(19) United States
(12) Patent Application Publication
(10) Pub. No.: US 2010/0163121 A1
(43) Pub. Date: Jul. 1, 2010

(54) VALVE CONTROL UNIT OF TANK LORRY

(76) Inventor: Young-Soo Choi, Gyeongsangbuk-do (KR)

Correspondence Address: CHRISTOPHER PAUL MITCHELL, 888 16TH ST., NW, SUITE 800, WASHINGTON, DC, 20006, US

(21) Appl. No.: 12/521,775

(22) PCT Filed: Jan. 2, 2008
(86) PCT No.: PCT/KR2008/000004

§ 371 Date: Mar. 8, 2010

(30) Foreign Application Priority Data
Jan. 3, 2007 (KR) 10-2007-0000798

(51) Int. Cl. F16K 21/04; F16K 31/12

(52) U.S. Cl. 137/512

(57) ABSTRACT

Disclosed therein is a valve control apparatus for a tank lorry. The valve control apparatus for the tank lorry includes a first control valve for opening and closing the oil feed valve by supplying compressed air to the oil feed valve or discharging the supplied compressed air to the outside, a second control valve for actuating the first control valve by the user's manual manipulation, an automatic closing valve for actuating the first control valve, a third control valve for selecting an operation of the automatic closing valve, and a pneumatic circuit for realizing functions of the control valves, wherein the control valves are general direction conversion valves for converting a flow of the compressed air and can be controlled on the road. So, a user can carry out a loading work in more convenient and safe when the user loads oil articles or chemicals on a storage tank mounted on the tank lorry.

### TECHNICAL FIELD

The present invention relates to a valve control apparatus for a tank lorry, and more particularly, to a valve control apparatus for a tank lorry, which can supply a load and stop the supply of the load manually by a user's direct manipulation of the valve control apparatus when oil articles or chemicals are loaded on a storage tank mounted on the tank lorry, and which can automatically finish a loading work in case where the load is supplied to the maximum loadage and can be actuated by air pressure without using any electric device, thereby providing convenience in work through the automated loading work and securing safety since the electric device is not used.

### BACKGROUND ART

As shown in FIGS. 1 and 2, a tank lorry for transporting a load, such as oil articles or chemicals, includes: a storage tank 100 mounted thereon; a plurality of partitions 110 adapted to divide the inside of the storage tank 100 into a plurality compartments; openings 120 respectively formed on the compartments of the divided storage tank 100; a limit indicating point 130 formed on the inner surface of each opening 120 for indicating the maximum loadage; an oil feed hole 140 formed on the bottom surface of the inside space of each compartment; an oil feed valve 160 mounted on the oil feed hole 140; an oil feed pipe 150 mounted below the storage tank 100 for receiving the load from the oil feed pipe 150 or discharging the load; and a control valve 170 mounted on the upper portion of the storage tank 100 for opening and closing the oil feed valve 160 by air pressure of a compressed air tank (T) mounted on the tank lorry.

Furthermore, the tank lorry further includes a ventilation pipe 180 mounted above the storage tank 100 and communicating with each compartment of the storage tank 100, and the ventilation pipe 180 includes a number of ventilation pipes 181 adapted to communicate the ventilation pipe 180 with each compartment of the storage tank 100 and a ventilation cutoff valve 185 formed at an end of the ventilation pipe 180 for cutting off ventilation. Meanwhile, the oil feed pipe 150 includes an oil-feeding cutoff valve 155 formed at an end thereof.

A load supplying process of the general tank lorry having the above structure will be described. After a supply line of a load supply terminal (not shown) is connected to the end of the oil feed pipe 150 of the tank lorry and the oil-feeding cutoff valve 155 is opened, when a user opens the control valve 170 at the top of the tank lorry, the air pressure of the compressed air tank (T) of the tank lorry is transferred to the oil feed valve 16 to thereby open the oil feed valve 160, so that the user can supply the load to the tank lorry.

Thereafter, the user opens a lid of the opening part 120 and checks a state where the load is supplied up to the limit indicating point 130 with naked eyes. When the load reaches the maximum loadage, the user closes the control valve 170 to intercept the introduction of the compressed air into the oil feed valve 160, whereby the oil feed valve 160 is closed. The user closes the opening 120 to finish the loading work to the inside of each compartment of the storage tank 100. When the loading of all compartments of the storage tank is finished, finally, the oil-feeding cutoff valve 155 of the oil feed pipe 150 is closed on the road and the supply of the load from the load supply terminal is stopped to thereby finish the loading work.

In the meantime, when the load is supplied or discharged, the ventilation cutoff valve 185 formed on the ventilation pipe 180 and the plural ventilation valves 181 are opened to communicate the inside of the storage tank 100 with the outside, whereby the load can be supplied or discharged smoothly.

However, the general tank lorry described above has several problems in that it is inconvenient in operation since the user has to supply the load by directly opening the opening 120 and checking the inside state of the storage tank 100 with the eyes at the top of the storage tank 100, in that there are some risks of an explosion and a fire when flammable materials such as the oil are loaded, and in that it may cause an environmental pollution and the user may be exposed to toxic chemicals since evaporated toxic chemicals are discharged to the air when the toxic chemicals are loaded thereon.

Meanwhile, in order to solve the above-mentioned problems of the tank lorry, recently, gauge devices for allowing the user to check the inside state of the storage tank without opening the opening part and valve control apparatus for controlling the oil feed valve on the load have been disclosed. However, the improved valve control apparatus using an electric device according to the prior art has a problem in that the user evades using the tank lorry since safety is not secured due to the electric device, and the valve control apparatus not using the electric device also has a problem in that it is inconvenient in manufacturing and use since its configuration is complicated.

### DISCLOSURE OF INVENTION

### Technical Problem

Accordingly, the present invention has been made in an effort to solve the above-mentioned problems occurring in the prior arts, and it is an object of the present invention to provide a valve control apparatus for a tank lorry, which can allow a user to supply a load and stop the supply of the load on the road by manipulating the valve control apparatus when oil articles or chemicals are loaded on a storage tank mounted on the tank lorry, which can automatically close an oil feed valve when the load is supplied to the maximum loadage, which can secure safety since any electric device is not used, and which is convenient in manufacturing and use.

The valve control apparatus for the tank lorry includes a first control valve for opening and closing the oil feed valve by supplying compressed air to the oil feed valve or discharging the supplied compressed air to the outside, a second control valve for actuating the first control valve by the user's manual manipulation, an automatic closing valve for actuating the first control valve, a third control valve for selecting an operation of the automatic closing valve, and a pneumatic circuit for realizing functions of the control valves, wherein the control valves are general direction conversion valves for converting a flow of the compressed air and can be controlled on the road.

### Technical Solution

To achieve the above objects, the present invention provides a valve control apparatus for a tank lorry, which is adapted to open and close an oil feed valve mounted on the bottom surface of a storage tank by controlling air pressure of a compressed air tank mounted on the tank lorry, the valve control apparatus comprising: a first control valve for opening and closing the oil feed valve by supplying compressed air to the oil feed valve or discharging the supplied compressed air to the outside; a shuttle valve serving as a direction conversion valve adapted for actuating the first control valve by discharging the compressed air introduced from one of inlets to the pilot port of the first control valve through a single outlet; a second control valve serving as a direction conversion valve for actuating the first control valve by supplying the compressed air to one inlet of the shuttle valve or discharging the supplied compressed air to the outside; a third control valve serving as a direction conversion valve for supplying the compressed air to the automatic closing valve mounted on the upper portion of the storage tank or discharging the supplied compressed air to the outside; the automatic closing valve adapted to discharge the compressed air introduced from the third control valve to the other inlet of the shuttle valve according to an actuation of an air tank having buoyancy against a load to thereby actuate the first control valve; and an oil feed valve opened when the compressed air is supplied from the first control valve to one of two ports thereof, the oil feed valve being closed by an actuation of the compression spring and keeping the closed state by introducing the compressed air to the other port thereof when the supplied compressed air is discharged to the outside.

### ADVANTAGEOUS EFFECTS

As described above, the valve control apparatus of the tank lorry according to the present invention can allow the user to stop the supply of the load manually by directly manipulating the valve control apparatus on the road when oil or chemicals are loaded on the storage tank mounted on the tank lorry, automatically end the loading when the load is supplied to the maximum loadage to thereby achieve an automated loading work, and secure safety since the electric device is not used.

### BRIEF DESCRIPTION OF THE DRAWINGS

FIGS. 1 and 2 are configurative views of a general tank lorry.

FIGS. 3 to 5 are schematic diagrams and signs of well-known direction conversion valves.

FIGS. 6 to 10 are configurative views showing an operational state of a valve control apparatus according to the present invention.

FIG. 11 is a configurative view of a control box of the valve control apparatus according to the present invention.

FIG. 12 is a sectional view of a first control valve of the valve control apparatus.

FIG. 13 is a sectional view of an automatic closing valve of the valve control apparatus.

FIG. 14 is a sectional view of an oil feed valve of the valve control apparatus.

FIG. 15 is a sectional view of a ventilation valve of the valve control apparatus.

### EXPLANATION ON REFERENCE NUMERALS OF MAIN ELEMENTS IN DRAWINGS

10: first control valve 20: second control valve

30: third control valve 40: shuttle valve

50: automatic closing valve 60: oil feed valve

70: main valve 80: ventilation valve

90: control box 100: storage tank

140: oil feed hole 150: oil feed pipe

180: ventilation pipe T: compressed air tank

### MODE FOR THE INVENTION

Before a detailed configuration of a valve control apparatus according to the present invention will be described, well-known direction control valves will be first described. The direction control valve is a valve to control a flow direction of a fluid and has at least two ports and at least two operational ways. The direction conversion valves are classified into a 2 port-2 way valve, a 3 port-2 way valve, a 4 port-3 way valve, and a 5 port-2 way valve according to the numbers of the ports and ways, into a man power type valve such as a button type, a lever type and a pedal type, a mechanical type valve such as a plunger type and a roller type, a pneumatic type valve of direct or indirect pilot type, and an electronic type valve according to manipulation methods, and into a spring return type valve and a self-location keeping type valve according to returning methods or keeping methods.

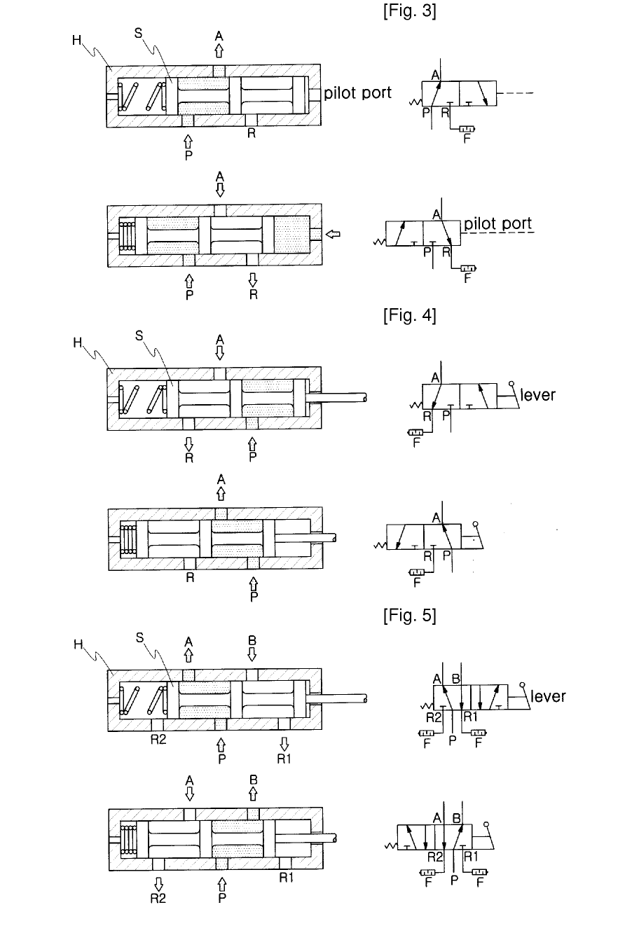

Referring to FIGS. 3 to 5, out of the above-mentioned direction conversion valves, direction conversion valves related with the present invention will be described in brief with their signs. FIG. 3 illustrates a 3 port-2 way pneumatic type direction conversion valve, FIG. 4 illustrates a 3 port-2 way lever type direction conversion valve, and FIG. 5 illustrates a 5 port-2 way lever type direction conversion valve. The direction conversion valves illustrated in the drawings are to convert a flow of air among a supply line (P), working lines (A) and (B) and discharge lines (R), (R1) and (R2) according to an operation of a spool (S) inserted into a housing (H). The direction conversion valve shown in FIG. 3 sends a compressed air, which is introduced into the supply line (P), to the working line (A) according to a location of the spool (S) kept by a compression spring ordinarily, and in this instance, when a different compressed air is introduced into a pilot port formed on a side of a housing (H), the spool (S) is actuated and the compressed air introduced into the working line (A) is discharged to the discharge line (R). The direction conversion valve shown in FIG. 4 discharges the compressed air introduced into the supply line (P) to the working line (A) or discharges the compressed air introduced into the working line (A) to the discharge line (R) according to an operation of a lever for actuating the spool (S). Further, the direction conversion valve shown in FIG. 5 discharges the compressed air introduced into the supply line (P) to one of the two working lines (A) and (B) and simultaneously discharges the compressed air introduced into the other working line to the discharge line (R1) or (R2) corresponding to the working line according to the operation of the lever for actuating the spool (S). In the meantime, FIGS. 3 and 4 illustrate an example of the 3 port-2 way direction conversion valve. In FIGS. 3 and 4, the supply line (P) and the discharge line (R) may be changed. In the drawings, the unexplained reference sign “F” designates a discharge filter (F).

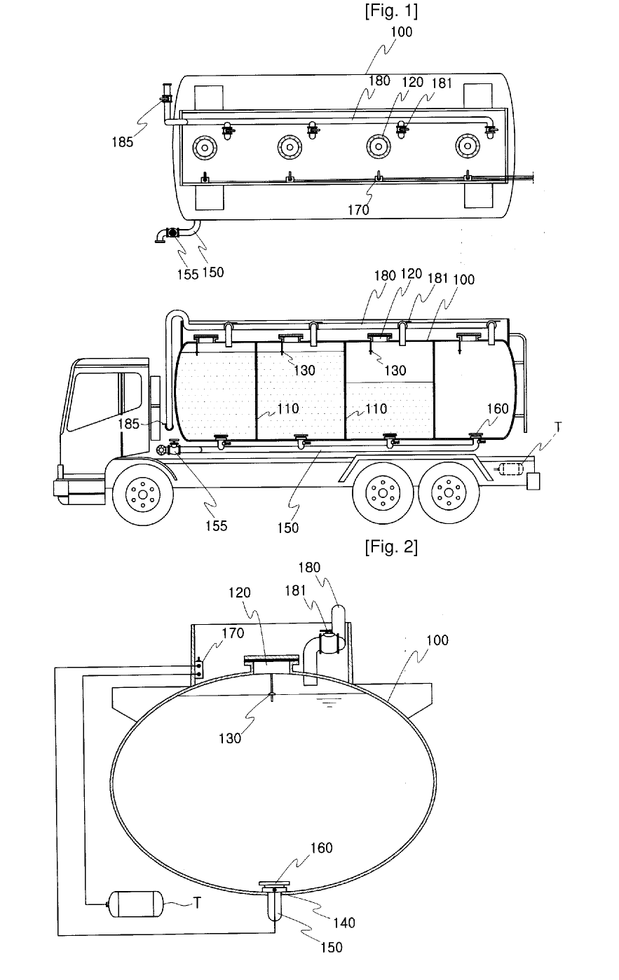

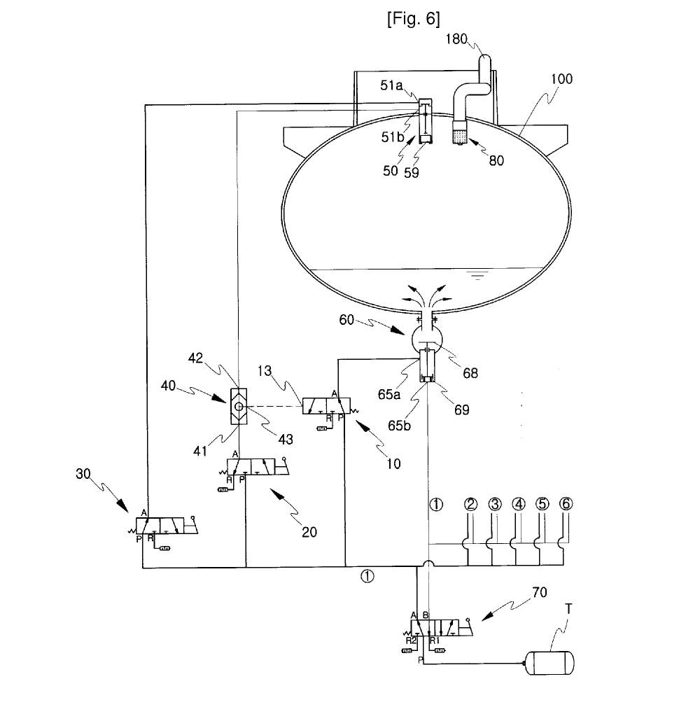

Hereinafter, referring to FIGS. 6 to 10, the structure of the valve control apparatus of the tank lorry according to a preferred embodiment of the present invention will be described in detail. In this instance, in order to avoid repeated description of the same parts as FIGS. 1 to 5, the same parts as FIGS. 1 to 5 have the same reference numerals and signs as FIGS. 1 to 5.

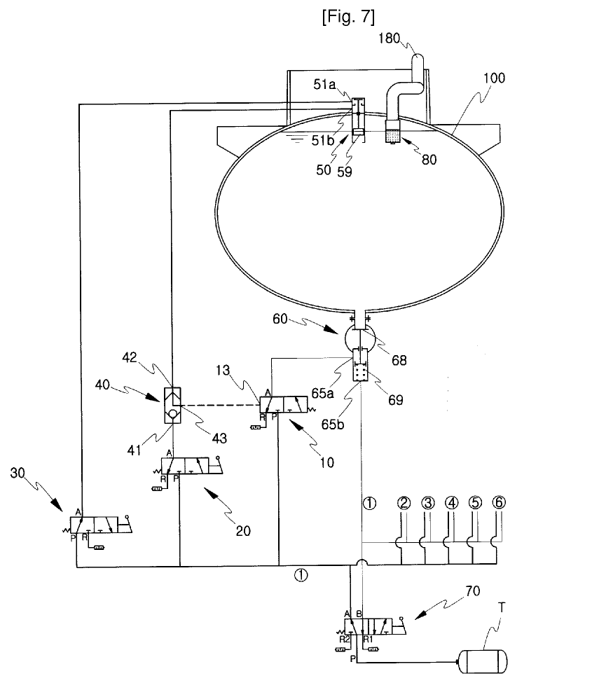

In the valve control apparatus according to the present invention, a number of control valves 10, 20 and 30, a shuttle valve 40 and an automatic closing valve 50 adapted to open and close an oil feed valve 60 mounted on the bottom surface of a storage tank 100 by controlling air pressure of a compressed air tank (T) are connected with one another via a pneumatic circuit. The first control valve 10 is a 3 port-2 way pneumatic type direction conversion valve actuated by air pressure of the compressed air transferred to a pilot port 13 formed on a side thereof. While the first control valve 10 normally discharges the compressed air introduced from the supply line to a port 65a of the oil feed valve 60 through the working line (see FIG. 6), when the compressed air is introduced into the pilot port 13 through another path, the first control valve 10 stops a flow of the compressed air introduced from the supply line through a converting action and simultaneously discharges the compressed air, which is discharged to the oil feed valve 60 through the working line, to the air through the discharge line to thereby close the oil feed valve 60. (See FIG. 7)

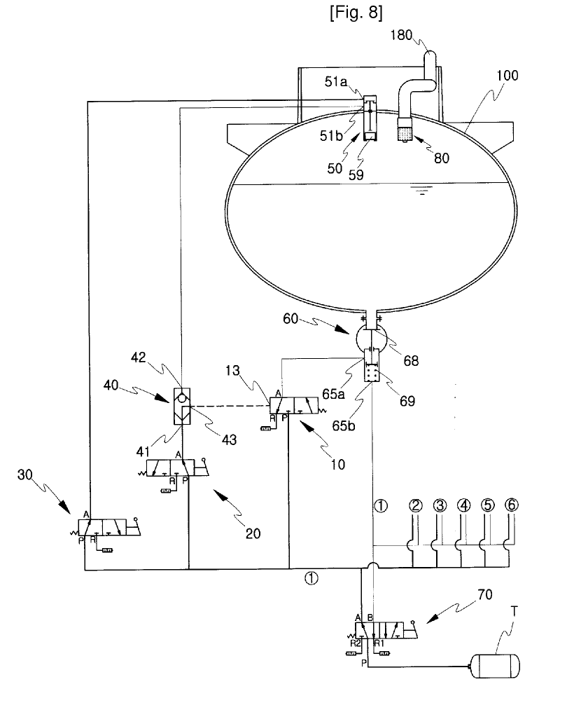

In the meantime, the compressed air introduced to the pilot port 13 of the first control valve 10 is introduced through a general shuttle valve 40, and the shuttle valve 40 includes a pair of inlets 41 and 42 and an outlet 43. So, the shuttle valve 40 receives the compressed air from one inlet, to which compressed air of a relative higher pressure is introduced, and discharge the compressed air to the outlet 43. The outlet 43 of the shuttle valve 40 is connected with the pilot port 13 of the first control valve 10, and so, the first control valve 10 is converted by the compressed air introduced into the inlets 41 and 42 of the shuttle valve 40. (See FIGS. 7 and 8)

The second control valve 20 is a 3 port-2 way lever type direction control valve. The second control valve 20 discharges the compressed air, which is introduced into the supply line, to the inlet 41 of the shuttle valve 40 through the working line according to an operation of a lever of the second control valve 20 (see FIG. 8), or stops a flow of the compressed air introduced from the supply line and simultaneously discharges the compressed air, which is introduced through the inlet 41 of the shuttle valve 40, through the discharge line (see FIG. 6), whereby the second control valve 20 can control the actuation of the first control valve 10 by a manual manipulation of the lever of the second control valve 20. While the second control valve 20 ordinarily keeps a closed state to stop the flow of the compressed air introduced from the supply line, the second control valve 20 is opened in case where a user wants to stop a loading work by closing the oil feed valve 60 at any loadage as shown in FIG. 8.

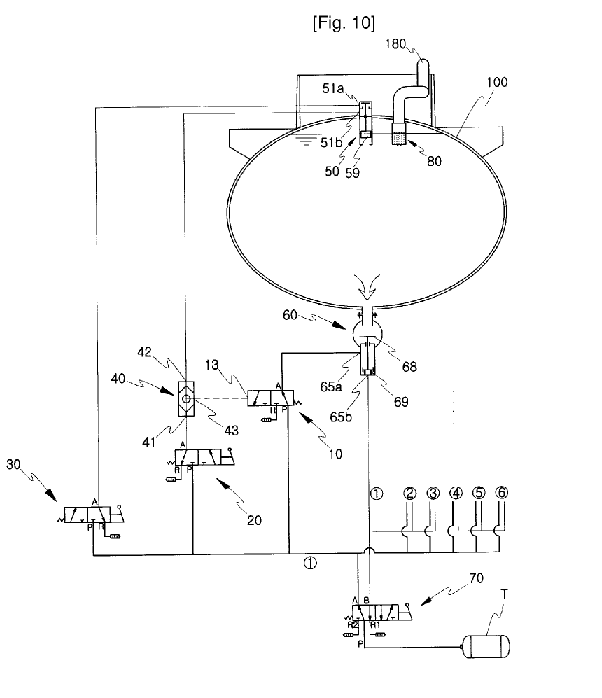

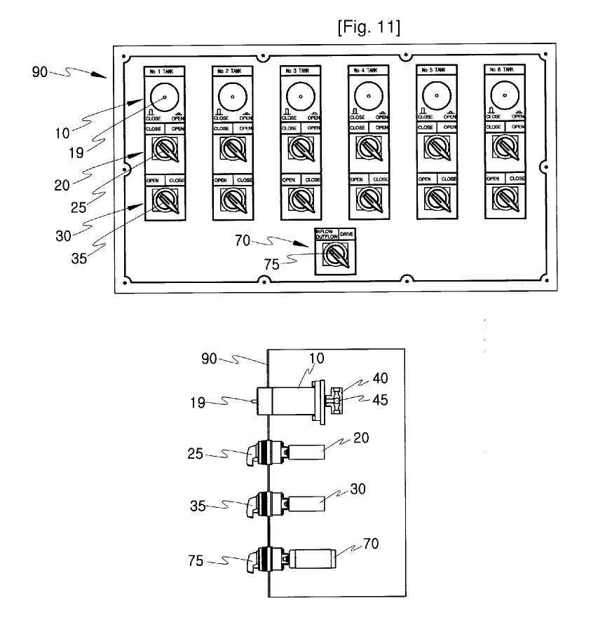

The third control valve 30 is a 3 port-2 way lever type direction conversion valve. The third control valve 30 discharges the compressed air, which is introduced into the supply line, to the automatic closing valve 50 through the working line according to an operation of a lever of the third control valve 30 (see FIG. 6), or stops the flow of the compressed air introduced from the supply line and simultaneously discharges the compressed air, which is introduced to the automatic closing valve 50, through the discharge line (see FIG. 10), whereby the third control valve 30 can control the actuation of the automatic closing valve 50 by the manual manipulation of the lever of the second control valve 20. While the third control valve 30 ordinarily keeps an opened state to discharge the compressed air introduced from the supply line to the automatic closing valve 40, the third control valve 30 is closed in case where the user wants to forcedly discharge the loadage in a state where the storage tank is filled with the load as shown in FIG. 10.

Moreover, the configuration of the automatic closing valve 50 will be described. The automatic closing valve 50 includes an intake hole 51a connected with the working line of the third control valve 50 for introducing the compressed air and an discharge hole 51b for discharging the compressed air introduced from the intake hole 51a to the inlet 42. The automatic closing valve 50 is mounted in such a way as to pass through the upper portion of the storage tank 100, and further includes an air tank 59 formed on the lower portion thereof and having buoyancy against the load to thereby control the flow of the compressed air between the intake hole 51a and the discharge hole 51b according to a vertical movement of the air tank 59. As shown in FIG. 7, when the load is supplied up to the maximum loadage of the storage tank 100 and the air tank 59 is submerged in the load, the automatic closing valve 50 is opened due to a rise of the air tank 59 having buoyancy. Hence, when the compressed air supplied to the automatic closing valve 50 is introduced into the pilot port 13 of the first control valve 10 through the shuttle valve 40, the oil feed valve 60 is closed by the conversion action of the first control valve 10, whereby the loading work is automatically finished by the actuation of the automatic closing valve 50 when the load is supplied up to the maximum loadage.

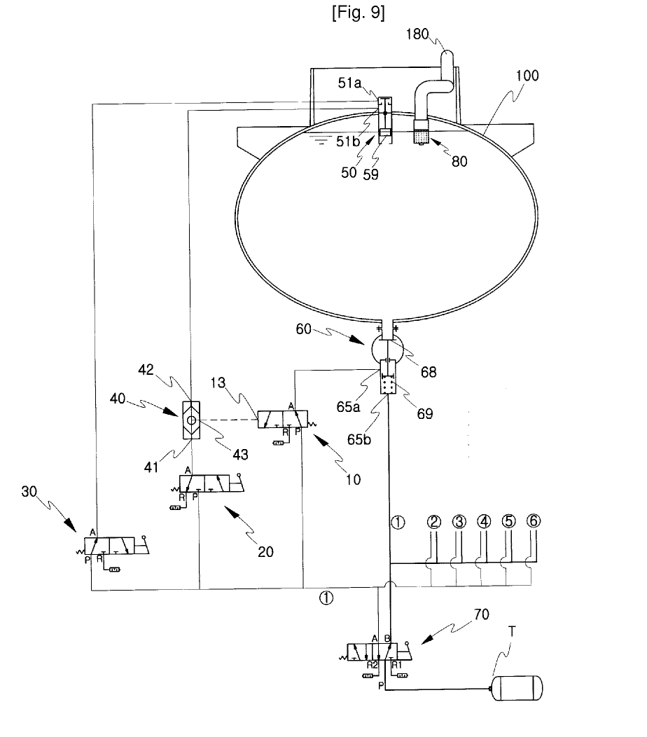

In addition, while the oil feed valve 60 keeps a closed state of a valve disc 68 by a compression spring 69 in a unloading state, the valve disc 68 is opened (see FIG. 6) when the compressed air is supplied from the first control valve 10 to one of two ports 65a and 65b thereof, but is closed by the operation of the compression spring 69 (see FIGS. 7 and 8) when the supplied compressed air is discharged. Meanwhile, the compressed air is introduced into the other port 65b of the oil feed valve 60 to thereby keep the closed state of the oil feed valve 60. (See FIG. 9)

In the meantime, the valve control apparatus according to the present invention includes valve control apparatus and pneumatic circuits \textcircled{1} to \textcircled{6} of the same number as compartments formed by dividing the inner space of the storage tank 100 to thereby independently control each compartment of the storage tank 100. While the compressed air supplied to the supply lines of the first control valve 10, the second control valve 20 and the third control valve 30 of each valve control apparatus and the compressed air supplied to the port 65b of the oil feed valve 60 can be directly supplied from the compressed air tank (T) of the tank lorry, it is more preferable that the compressed air of the compressed air tank (T) is supplied and discharged to the control valves 10, 20 and 30 and the oil feed valve 60 through a single main valve 70 to thereby collectively control the control valves 10, 20 and 30 of the valve control apparatus and the oil feed valve 60.

Hereinafter, a structure of the main valve 70 will be described in more detail. The main valve 70 is a 5 port-2 way lever type direction conversion valve for converting a flow of the compressed air according to an operation of a lever. The main valve 70 supplies the compressed air of the compressed air tank (T), which is introduced to the supply line, to the control valves 10, 20 and 30 through one of the working lines when the load is supplied to or discharged from the storage tank 100, and simultaneously discharges the compressed air, which is supplied to the port 65b of the oil feed valve 60 through the other working line, to one of the discharge lines. However, when the tank lorry runs, the main valve 70 discharges the compressed air, which is supplied to the control valves 10, 20 and 30 through the one working line, through the other discharge line, and simultaneously supplies the compressed air of the compressed air tank (T), which is introduced to the supply line, to the port 65b of the oil feed valve 60 through the other working line, whereby the oil feed valve 60 keeps the closed state.

In the meantime, as shown in FIG. 11, the control valves 10, 20 and 30 and the main valve 70 of the valve control apparatus for the tank lorry according to the present invention are mounted in a single control box 90. In this instance, it is preferable that the control box 90 is mounted on a side of the tank lorry in such a way as to be manipulated on the road. In the drawing, the unexplained reference numeral 25 designates the lever of the second control valve, 35 designates the lever of the third control valve 30, 75 designates the lever of the main valve, 45 designates a steel ball mounted inside the shuttle valve 40, and 19 designates a location check rod formed on the first control valve 10, which will be described later.

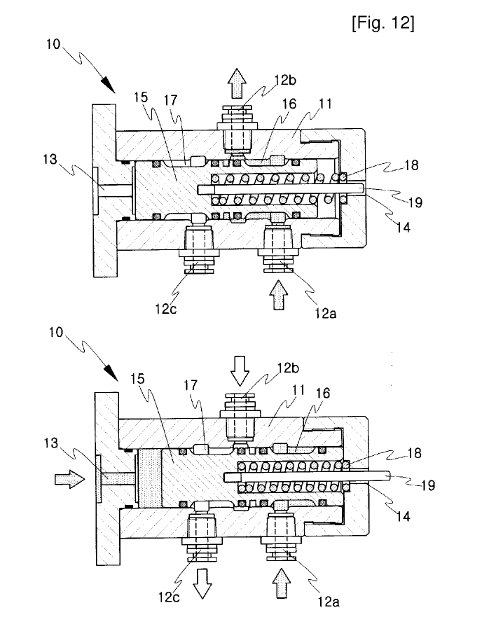

Hereinafter, referring to FIGS. 12 to 15, each of the components of the valve control apparatus for the tank lorry according to the present invention will be described in detail.

First, referring to FIGS. 6 and 12, the first control valve 10 will be described in detail. The first control valve 10 includes: a housing 11; an intake hole 12a connected to the supply line for allowing introduction of the compressed to the first control valve 10; a supply and discharge hole 12b connected with the working line for supplying the compressed air to the port 65a of the oil feed valve 60 or introducing the supplied compressed air thereto; a discharge hole 12c connected with the discharge line for discharging the compressed air introduced from the port 65a of the oil feed valve 60 to the air; the pilot port 13 formed on an end of the housing 11; and an air vent 14 formed on the other end of the housing 11.

Furthermore, a spool 15 actuating by the compressed air introduced into the pilot port 13 is inserted into the housing 11, and a compression spring 18 is mounted on a side of the inside of the housing 11 where the air vent 14 is formed, so that an end of the spool 15 is supported by the compression spring 18. The spool 15 has a pair of air passageways 16 and 17, so that the spool 15 communicates with the intake hole 12a and the supply and discharge hole 12b in order of intake hole 12a-air passageway 16-supply and discharge hole 12b or with the supply and discharge hole 12b and the discharge hole 12c in order of supply and discharge hole 12b-air passageway 17-discharge hole 12c according to an operational location of the spool 15.

Furthermore, the location check rod 19 inserted into and drawn out from the air vent 14 is formed on a side of the spool 15 supported by the compression spring 18, so that the user can check the operational location of the spool 15 from the outside. As shown in FIG. 11, the first control valve 10 is mounted in such a way that the user can check drawing-out of the location check rod 19 in front of the control box 90.

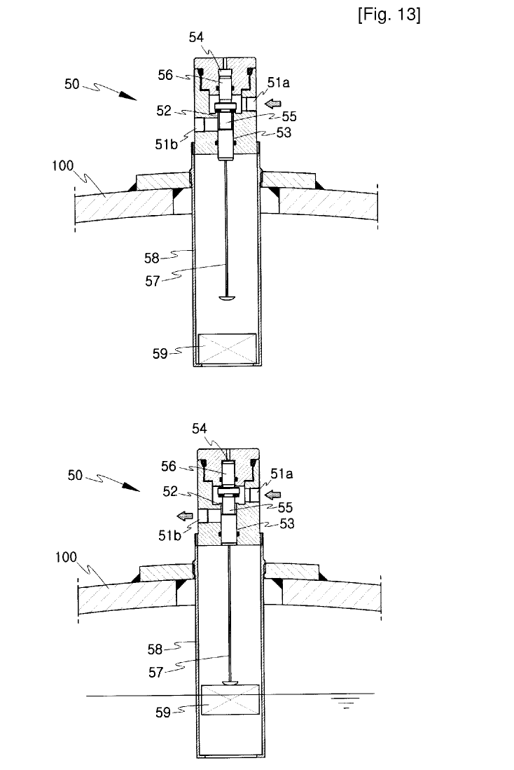

Referring to FIGS. 6 and 13, the automatic closing valve 50 will be described in detail. The automatic closing valve 50 includes: an intake hole 51a connected with the working line of the third control valve 30 for introducing the compressed air thereto; a discharge hole 51b for discharging the introduced compressed air to the inlet 42 of the shuttle valve 40; a valve seat 52 formed in the inner passageway of the automatic closing valve 50, which connects the intake hole 51 and the discharge hole 51b with each other; a guide hole 53 vertically and outwardly formed below the valve seat 52; a valve rod 55 inserted into the guide hole 53 in such a way as to be vertically operated for opening and closing the valve seat 52 and tightly sealed from the outside; and an elevation type push rod 57 formed on the lower end of the valve rod 55.

Additionally, the automatic closing valve 50 further includes a guide pipe 58 formed on the lower portion thereof and the elevation type push rod 57 is located inside the guide pipe 58. The guide pipe 58 passes through the upper portion of the storage tank 100, and air tank 59 having buoyancy, which is submerged in the load when the load is supplied up to the maximum loadage in the storage tank 100, is formed inside the guide pipe 58, so that the automatic closing valve 50 is opened according to a rising action of the air tank 59 when the load is supplied up to the maximum loadage.

Furthermore, the automatic closing valve 50 has a through hole 54 formed at the top thereof in such a way as to communicate the inside of the automatic closing valve 50 with the outside, and the through hole 54 is smaller than the inner diameter of the valve seat 52. The valve rod 55 has an insertion portion 56 integrally formed on the top thereof and inserted into the through hole 54 in such a way as to keep sealability to thereby reduce a sectional area of the valve rod 55 where pressure of the compressed air introduced into the intake hole 51a acts, whereby the automatic closing valve 50 can be opened even by the air tank 59 having a small buoyancy.

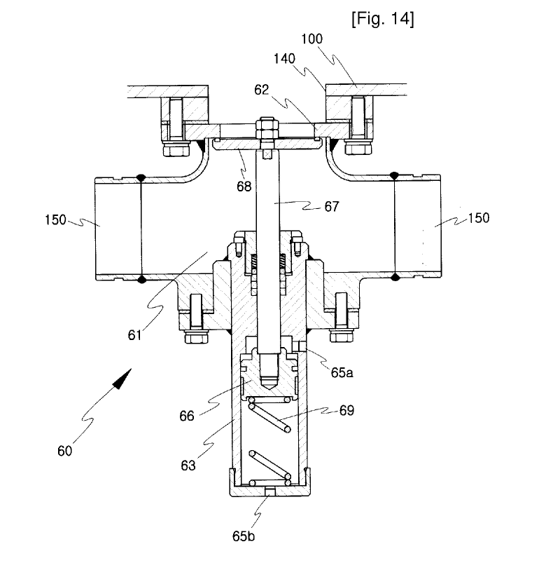

Referring to FIGS. 6 and 14, a structure of the oil feed valve 60 will be described in detail. A side or both sides of the oil feed valve 60 communicates with an oil feed pipe 150, and a pipe body 61 is formed on the upper portion of the oil feed valve 60 and communicates with an oil feed hole 140 of the storage tank 100. A seat portion 62 is formed on the inside upper portion of the pipe body 61 and a pneumatic cylinder 63 is formed on the lower portion of the pipe body 61. The pneumatic cylinder 63 includes: the port 65a connected with the working line of the first control valve 10 and formed on the upper portion thereof for allowing inflow and outflow of the compressed air; and the other port 65b connected with the working line of the main valve 70 and formed on the lower portion thereof for allowing inflow and outflow of the compressed air.

In addition, a piston 66 is inserted into the pneumatic cylinder 63, and in this instance, the bottom surface of the piston 66 is supported by the compression spring 69. A piston rod 67 extending to the inside of the pipe body 61 is formed on the upper portion of the piston 66, and the valve disc 68 is formed at the end of the piston rod 67 in such a way that the valve disc 68 is in close contact with the bottom surface of the seat portion 62, whereby the oil feed valve 60 is opened and closed according to the action of the compressed air supplied to and discharged from the pneumatic cylinder 63.

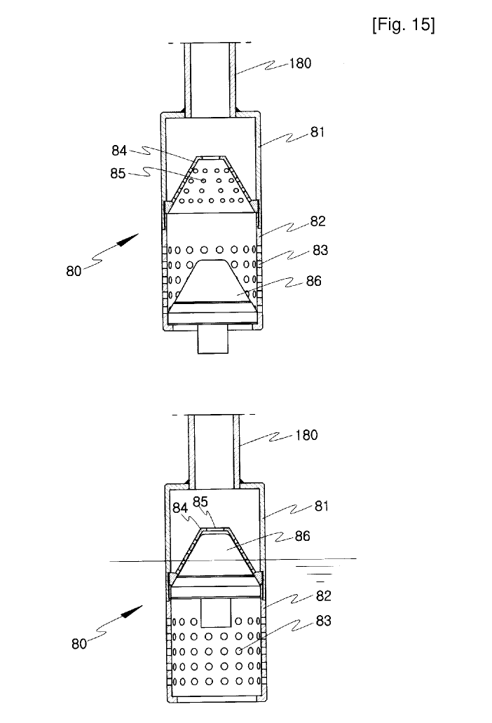

Meanwhile, referring to FIGS. 6 and 15, a structure of a ventilation valve 80 formed on the ventilation pipe 180 communicating with each compartment of the storage tank 100 will be described in detail. The ventilation valve 80 includes: an upper pipe body 81 formed at an end of the ventilation pipe 180 communicating with each compartment of the storage tank 100; a lower pipe body 82 attached on the lower end of the upper pipe body 81 and having a number of water flow holes 85; a cone-shaped support 84 formed between the upper pipe body 81 and the lower pipe body 82 and having a number of vent holes 85; and a conical stopper 86 formed inside the lower pipe body 82 for closing the vent holes 85 of the support 84 by rising by the buoyancy when the storage tank is filled with the load.

Referring to FIGS. 6 and 10, an action of the valve control apparatus for the tank lorry having the above configuration as described above will be described.

First, referring to FIG. 6, a supplied state of the load will be described. The compressed air of the compressed air tank (T) is supplied to the control valves 10, 20 and 30 through the main valve 70, and the compressed air introduced into the first control valve 10 is supplied to the port 65a of the oil feed valve 60, whereby the oil feed valve 60 is opened to thereby supply the load into the storage tank 100. In this instance, the second control valve 20 is in the closed state, the third control valve 30 is in the opened state, and the automatic closing valve 50 keeps the closed state. Meanwhile, the other port 65b of the oil feed valve 60 communicates with the air through the main valve 70 to keep an atmospheric pressure state.

In the above load supplying state, referring to FIG. 7, an automatic closing action of the oil feed valve 60 will be described. When the storage tank is filled with the load, the automatic closing valve 50 is opened by the rising of the air tank 59, and the compressed air introduced into the automatic closing valve 50 through the third control valve 30 is discharged to the pilot port 13 of the first control valve 10 through the shuttle valve 40 to thereby convert the first control valve 10. Accordingly, the compressed air introduced into the port 65a of the oil feed valve 60 is discharged to the air through the first control valve 10, whereby the oil feed valve 60 is closed by a restoring force of the compression spring 69.

Furthermore, in the above load supplying state, referring to FIG. 8, a manual closing action of the oil feed valve 60 will be described. When the user actuates the lever of the second control valve 20 at some loadage, the compressed air introduced into the second control valve 20 is discharged to the pilot port 13 of the first control valve 10 through the shuttle valve 40 to thereby convert the first control valve 10, and accordingly, the compressed air introduced into the port 65a of the oil feed valve 60 is discharged to the air through the first control valve 10, whereby the oil feed valve 60 is closed by the restoring force of the compression spring 69.

Meanwhile, in the automatic closing action and the manual closing action of the oil feed valve 60, the valve disc 68 of the oil feed valve 60 closed by the restoring force of the compression spring 69 firmly keeps the closed state by pressure of the load while the load is supplied.

Furthermore, after the automatic or manual supply of the load to the storage tank 100 is finished, as shown in FIG. 9, the main valve 70 is converted to thereby discharge the compressed air, which is supplied to the control valves 10, 20 and 30 and the automatic closing valve 50, to the air, and simultaneously introduces the compressed air of the compressed air tank (T) to the other port 65b of the oil feed valve 60, whereby the oil feed valve 60 can keep the closed state in stable during the operation of the tank lorry.

Hereinafter, referring to FIG. 10, the discharge of the supplied load will be described. The main valve 70 is converted in the same location as when the load is supplied and the third control valve 30 is converted. Then, the compressed air introduced into the automatic closing valve 50 is interrupted and discharged to the air, whereby the automatic closing valve 50 is not actuated. On the other side, the compressed air introduced into the first control valve 10 is supplied to the port 65a of the oil feed valve 60, so that the oil feed valve 60 is opened to thereby discharge the load.

In the mean time, the ventilation valve 80 formed on the ventilation pipe 180 is opened while the load is supplied or discharged, so that the inside of the storage tank communicates with the outside. Accordingly, the stopper disposed inside the ventilation valve 80 rises by the buoyancy when the storage tank is filled with the load, whereby the inside air of the storage tank is interrupted from the outside.

1. A valve control apparatus for a tank lorry, which is adapted to open and close an oil feed valve (60) mounted on the bottom surface of a storage tank (100) by controlling air pressure of a compressed air tank (T) mounted on the tank lorry, the valve control apparatus comprising:
a first control valve (10) serving as a direction conversion valve actuated by air pressure transferred to a pilot port (13) so as to open and close the oil feed valve (60) by supplying compressed air to the oil feed valve (60) or discharging the supplied compressed air to the outside;
a shuttle valve (40) adapted to discharge the compressed air introduced from one of inlets (41; 42) to the pilot port (13) of the first control valve (10) through a single outlet (43);
a second control valve (20) serving as a direction conversion valve for actuating the first control valve (10) by supplying the compressed air to one inlet (41) of the shuttle valve (40) or discharging the supplied compressed air to the outside;
a third control valve (30) serving as a direction conversion valve for supplying the compressed air to the automatic closing valve (50) mounted on the upper portion of the storage tank (100) or discharging the supplied compressed air to the outside;
the automatic closing valve (50) adapted to discharge the compressed air introduced from the third control valve (30) to the other inlet (42) of the shuttle valve (40) according to an actuation of an air tank (59) having buoyancy against a load to thereby actuate the first control valve (10); and an oil feed valve (60) having a pair of ports (65a; 65b), the oil feed valve (60) being opened when the compressed air is supplied from the first control valve (10) to the port (65a), the oil feed valve (60) being closed by an actuation of the compression spring (69) and keeping the closed state by introducing the compressed air to the other port (65b) when the supplied compressed air is discharged.

2. The valve control apparatus according to claim 1, further comprising a main valve (70) serving as a direction conversion valve adapted to supply the compressed air of the compressed air tank (T) to the first control valve (10), the second control valve (20) and the third control valve (30) and simultaneously discharge the supplied compressed air to the other port (65b) of the oil feed valve (60) when the load is supplied to or discharged from the storage tank (100), the main valve (70) being adapted to discharge the compressed air of the compressed air tank (T) supplied to the first control valve (10), the second control valve (20) and the third control valve (30) and simultaneously supply the compressed air of the compressed air tank (T) to the port (65b) of the oil feed valve (60), whereby the oil feed valve (60) keeps the closed state when the tank lorry runs.

3. The valve control apparatus according to claim 1 or 2, wherein the first control valve 10 comprises: a housing (11) having an intake hole (12a) for introducing the compressed air thereto, a supply and discharge hole (12b) communicating with the port (65a) of the oil feed valve (60) and a discharge hole (12c) communicating with the air; the pilot port (13) formed on a side of the housing (11); an air vent (14) formed on the other side of the housing (11); a spool (15) actuated by the compressed air introduced to the pilot port (13) inside the housing (11); a compression spring (18) inserted into the air vent (14) and supported by the spool (15); a pair of air passageways (16; 17) formed on the spool (15) for communicating the intake hole (12a) and the supply and discharge hole (12b) thereto or communicating the supply and discharge hole (12b) and the discharge hole (12c) thereto according to an operational location of the spool (15); and a location check rod (19) formed on a side of the spool (15), to which the compression spring (18) is supported, the location check rod (19) being inserted in and drawn out from the air vent (14), whereby a user can check the operational location of the spool (15) from the outside.

4. The valve control apparatus according to claim 1 or 2, wherein the automatic closing valve (50) comprises: an intake hole (51a) for receiving the compressed air from the third control valve (30); an discharge hole (51b) for discharging the introduced compressed air to the inlet (42) of the shuttle valve (40); a valve seat (52) formed between the intake hole (51a) and the discharge hole (51b); a guide hole (53) vertically and outwardly formed on the lower portion of the valve seat (52); a valve rod (55) inserted into the guide hole (53) for opening and closing the valve seat (52) by a vertical operation thereof in such a way as to keep sealability; an elevation type push rod (57) formed on the lower end of the valve rod (55); a guide pipe (58) passing through the upper portion of the storage tank (100) and formed in such a way that the elevation type push rod (57) is located inside the guide pipe (58); and the air tank (59) formed inside the guide pipe (58) in such a way as to rise by its buoyancy, whereby the automatic closing valve (50) is opened according to a rising action of the air tank (59).

5. The valve control apparatus according to claim 4, wherein the automatic closing valve (50) further comprises a through hole (54) formed on the top thereof for communicating the inside of the automatic closing valve (50) with the outside, and an insertion portion (56) formed on the top of the valve rod (55) and inserted into the through hole (54) in such a way as to keep sealability.

6. The valve control apparatus according to claim 2, wherein the oil feed valve (60) comprises: a pipe body (61) communicating with the oil feed pipe (150) at one or both sides thereof and communicating with an oil feed hole (140) of the storage tank (100) at the upper portion thereof; a seat portion (62) formed on the inside upper portion of the pipe body (61); a pneumatic cylinder (63) formed on the lower portion of the pipe body (61); a port (65a) formed on the upper portion of the pneumatic cylinder (63) for introducing from and discharging to the first control valve (10); another port (65b) formed on the lower portion of the pneumatic cylinder (63) for introducing from and discharging to the main valve (70); a piston (66) mounted inside the pneumatic cylinder (63) and supported by the compression spring (69); a piston rod (67) integrally formed on the upper portion of the piston (66) and extending to the inside of the pipe body (61); and a valve disc (68) formed at an end of the piston rod (67), the valve disc (68) being in close contact with the bottom surface of the seat portion (62), whereby the oil feed valve (60) is opened and closed according to the actuation of the pneumatic cylinder (63).
